(19) United States
(12) Patent Application Publication
(10) Pub. No.: US 2008/0239392 A1
(43) Pub. Date: Oct. 2, 2008

(54) IMAGE FORMING APPARATUS AND DATA PROCESSING METHOD

(75) Inventor: Yoshihito Nanaumi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/127,797

(22) Filed: May 27, 2008

Related U.S. Application Data
(63) Continuation of application No. PCT/JP2008/053675, filed on Feb. 29, 2008.

(30) Foreign Application Priority Data
Mar. 5, 2007 (JP) 2007-054887

(51) Int. Cl. G06F 3/12

(52) U.S. Cl. 358/1.15; 358/1.1

(57) ABSTRACT

An object of this invention is to increase the convenience for a user in setting a print reservation in an image forming apparatus having a time-designated print function. To achieve the object, according to the present invention, a control method of controlling an image forming apparatus communicably connected to a plurality of information processing apparatuses having a browser function includes the storage step of storing print data, the setting step of setting information representing a timing of printing the print data (S1201), the providing step of causing the image forming apparatus to be accessed via the browser function, receive the print request of the print data, and provide an object for counting the number of print requests as a web service (S1205), and the print step of printing the print data in number based on the counted number at the set timing (S1207 to S1210).

### TECHNICAL FIELD

The present invention relates to an image forming apparatus for printing a print job at a timing designated in advance and a data processing method.

### BACKGROUND ART

Recent image forming apparatuses such as a copying machine and a printer are becoming more multifunctional and obtaining various functions convenient for users.

For example, Japanese Patent Laid-Open No. 10-133530 discloses an image forming apparatus having a time-designated print function of storing a print job and outputting it at a designated time. This image forming apparatus has a function of avoiding printing that has started from remaining unfinished due to a shortage of paper sheets.

Japanese Patent Laid-Open No. 2004-262078 discloses an image forming apparatus with a time-designated print function, which has a function of counting the already reserved number of paper sheets and comparing it with the contents of a paper feed tray in setting a print reservation. This allows determining whether the paper feed tray is storing paper sheets necessary for the print reservation setting and reliably print the reserved number of paper sheets without worrying about any shortage of paper sheets during printing.

In use of such a multifunctional image forming apparatus, various proposals for improving the operation efficiency can be made. For example, such an image forming apparatus is installed in a meeting room. When a user makes a print reservation for copies of a meeting material for all meeting participants at the starting time of the meeting, he/she can reliably receive the desired number of copies of the material in the meeting room at the start of meeting.

### DISCLOSURE OF INVENTION

### Problems that the Invention is to Solve

However, in using the above-described multifunctional image forming apparatus, the print reservation setting requires a lot of time. Particularly, to make a print reservation of copies for all meeting participants, the user must reset the reserved number of copies in accordance with an increase or decrease in the number of participants, but it is inconvenient for him/her to go to the meeting room every time. For this reason, the operation is preferably made as simple as possible to increase the convenience for the user.

The present invention has been made in consideration of the above problem, and has as its object to increase the convenience for a user in setting a print reservation in an image forming apparatus having a time-designated print function.

### Means of Solving the Problems

In order to achieve the above object, an image forming apparatus according to the present invention has the following arrangement. That is, there is provided an image forming apparatus communicably connected to a plurality of information processing apparatuses, comprising:

a storage unit configured to store print data;

a setting unit configured to set information representing a timing of printing the print data;

a count unit configured to receive a print request of the print data from any one of the plurality of information processing apparatuses and counting the number of print requests; and

a print unit configured to print the print data in a number based on the counted number at the set timing.

### EFFECTS OF THE INVENTION

According to the present invention, it is possible to increase the convenience for a user in setting a print reservation in an image forming apparatus having a time-designated print function.

Other features and advantages of the present invention will become apparent from the following description of exemplary embodiments with reference to the attached drawings. The same reference numerals denote the same or similar parts throughout the drawings.

### BRIEF DESCRIPTION OF DRAWINGS

FIG. 1 is a view showing an example of the overall arrangement of an image forming system having an image forming apparatus (107) according to the first embodiment of the present invention;

FIG. 2 is a block diagram showing the functional arrangement of the image forming apparatus (107) according to the first embodiment of the present invention;

FIG. 3 is a view showing details of an operation unit 202 of the image forming apparatus 107;

FIG. 4 is a view showing an example of an operation screen displayed by pressing an “option 1” tab 314;

FIG. 5 is a view showing an example of a user selection screen displayed by pressing a user setting button 406;

FIG. 6 is a view showing an example of an output location designation screen displayed by pressing a location setting button 407;

FIG. 7 is a view showing an example of a time designation screen displayed by pressing a time setting button 408;

FIG. 8 is a view showing an example of a print reservation setting registration state display screen displayed by pressing a task status button 411;

FIG. 9 is a view showing an example of an advanced setting screen displayed by pressing an advanced setting button 412 in FIG. 4;

FIG. 10 is a view showing an example of a web site generated in an “option 2” tab 315 and accessibly provided to information processing apparatuses 103 and 104;

FIG. 11 is a view showing an example of meeting information mail generated in a “send” tab 312 and sent to the information processing apparatuses 103 and 104;

FIG. 12 is a flowchart illustrating the sequence of a time-designated print process in the image forming system according to the first embodiment of the present invention;

FIG. 13 is a block diagram showing the arrangement of an information processing apparatus 104 in an image forming system according to the second embodiment of the present invention;

FIG. 14 is a view showing an example of a dialogue of a printer driver 1313, which is displayed by selecting a print instruction in a document creation application 1311;

FIG. 15 is a view showing an example of a property setting screen;

FIG. 16 is a view showing an example of an option screen to input a scheduled print time, output location, user information, and customized mail text for time-designated printing via the printer driver 1313;

FIG. 17 is a view showing another example of the option screen to input a scheduled print time, output location, user information, and customized mail text for time-designated printing via the printer driver 1313; and

FIG. 18 is a flowchart illustrating the sequence of a process of each apparatus for a time-designated print process in the image forming system according to the second embodiment of the present invention.

### BEST MODE FOR CARRYING OUT THE INVENTION

The embodiments will now be described in detail with reference to the accompanying drawings, as needed.

### First Embodiment

### <1. Overall Arrangement of Image Forming System>

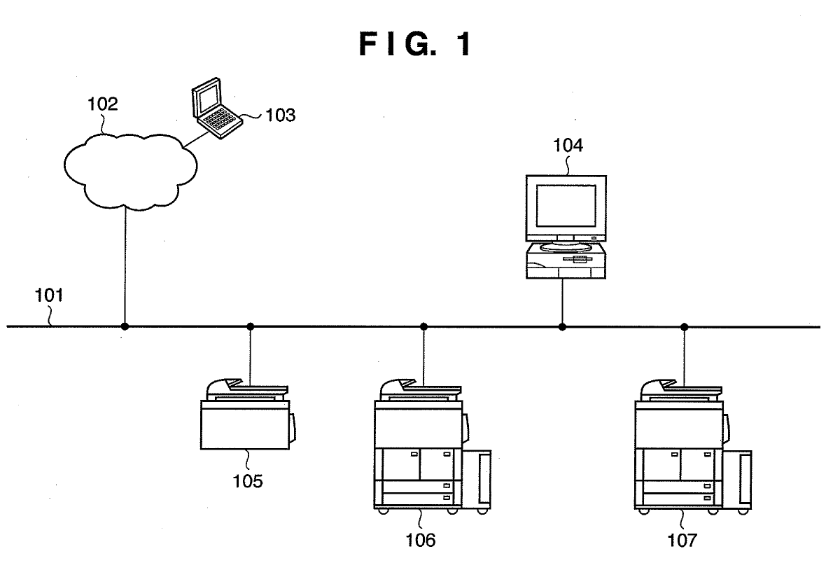

FIG. 1 is a view showing an example of the overall arrangement of an image forming system having an image forming apparatus (107) according to the first embodiment of the present invention.

Reference numeral 101 in FIG. 1 denote a LAN (Local Area Network). Each of information processing apparatuses 103 and 104 has the hardware resource of a so-called PC (Personal Computer). Both of the information processing apparatuses 103 and 104 have a browser function of accessing a web site (object) provided by the web server function (to be described later in detail) of the image forming apparatus 107. They also have a mail receiving function of receiving mail sent by the mail sending function (to be described later in detail) of the image forming apparatus 107.

Reference numerals 106 and 107 denote image forming apparatuses of MFP (Multi Function Peripheral) type. Reference numeral 105 denotes an image forming apparatus of SFP (Single Function Peripheral) type.

The information processing apparatus 104 and the image forming apparatuses 105 to 107 are directly connected to the LAN 101. The information processing apparatus 103 is connected to the LAN 101 via an Internet 102. These apparatuses connected to the LAN 101 can communicate with each other using a predetermined protocol.

### <2. Arrangement of Image Forming Apparatus>

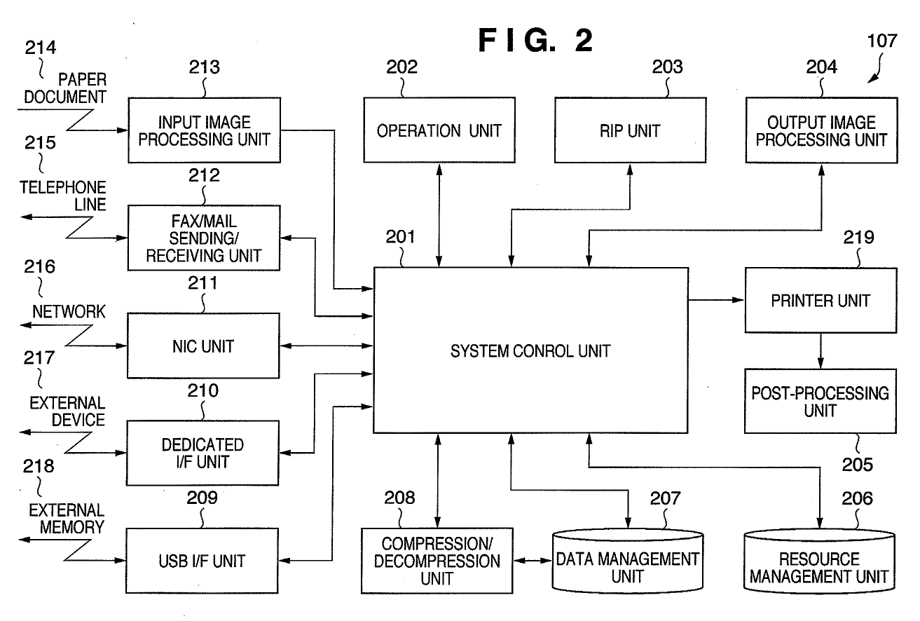

FIG. 2 is a block diagram showing the functional arrangement of the image forming apparatus (107) according to the first embodiment of the present invention.

Referring to FIG. 2, an input image processing unit 213 reads the image of, for example, a paper document 214 and processes the read image data. A FAX/mail sending/receiving unit 212 sends/receives FAX or mail using a telephone line 215. Use of the FAX/mail sending/receiving unit 212 implements the “mail sending function”. Mail of, for example, meeting information is sent to the information processing apparatuses 103 and 104 using the mail sending function.

A NIC (Network Interface Card) unit 211 exchanges a print job or device information with the information processing apparatus 103 or 104 using a network 216.

A dedicated I/F unit 210 exchanges information such as image data with an external device 217 (e.g., external hard disk). A USB (Universal Serial Bus) I/F unit 209 exchanges information such as image data with a USB device represented by a USB memory (a kind of removable medium) 218.

A system control unit 201 executes a control process to, for example, temporarily store image data in accordance with the application purpose or determine the route of a print job.

A data management unit 207 includes a memory such as a hard disk capable of storing a plurality of image data. The data management unit 207 can store image data in the memory or read out image data from the memory under the control of the system control unit 201.

The image forming apparatus 107 implements a “copy” function by causing a printer unit 219 to print, via the memory, image data input via the input image processing unit 213. The image forming apparatus 107 also implements a “print” function by receiving a print job output from the information processing apparatus 103 or 104 via the NIC unit 211 and causing the printer unit 219 to print the print job via the memory. In implementing the print function, if a print job received via the NIC unit 211 is PDL data, a RIP unit 203 executes a RIP process, and an output image processing unit 204 executes image processing for printing as needed. Note that RIP is short for “Raster Image Processor”.

The data management unit 207 can store print ready data (bitmap data for printing or compressed data thereof) created then again as needed (this function is called a “box function”). The box function includes box scan, box print, box reception, box sending, and various other functions requiring data write and read (input and output) using the data management unit 207. More specifically, the memory in the data management unit 207 is divided for each print job or each user, and data is temporarily stored in it. The data is input or output in combination with a user ID or a password.

A compression/decompression unit 208 compresses image data to be stored in the data management unit 207, as needed. The compression/decompression unit 208 also decompresses compressed image data read out from the data management unit 207.

A resource management unit 206 stores various kinds of parameter tables such as fonts, color profiles, and gamma table, which can be invoked as needed. The resource management unit 206 can also store a new parameter table, or correct and update an existing parameter table.

The printer unit 219 executes image formation. Sheets printed by the printer unit 219 are sent to a post-processing unit 205 to perform sheet sorting or sheet finishing.

An operation unit 202 includes a touch panel unit and a key input unit and is used to select a function or input an operation instruction. The operation unit 202 may use a high-resolution touch panel unit to additionally have a function of displaying a preview of image data in the data management unit 207 before printing. If the user confirms the preview image and gives a go-ahead, printing starts.

The image forming apparatus 107 has a web server function, in addition to the functions described above with reference to FIG. 2, to provide a web site to the information processing apparatuses 103 and 104. When mail of, for example, meeting information is sent to the information processing apparatus 103 or 104 using the mail sending function, the web site provided in this embodiment allows the recipient to input whether to require the material of the meeting (print request). That is, the user can access the web site via the browser function of the information processing apparatus 103 or 104 and input a print request. The image forming apparatus 107 counts print requests and sets a print reservation, thereby determining the number of paper sheets necessary for time-designated print function.

### <3. Arrangement of Operation Unit of Image Forming Apparatus>

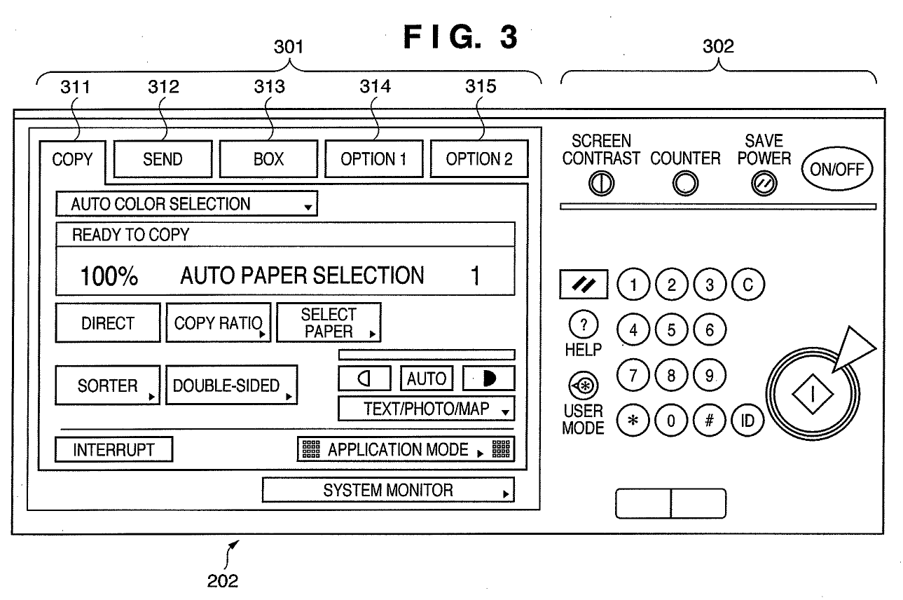

Details of the operation unit 202 of the image forming apparatus 107 will be described next with reference to FIG. 3.

FIG. 3 is a view showing details of the operation unit 202 of the image forming apparatus 107. As shown in FIG. 3, the operation unit 202 has a key input unit 302 and a touch panel unit 301.

The key input unit 302 is a key input portion capable of steady operation settings and includes a start key, stop key, ten-key pad, clear key, reset key, and user mode key. A detailed description of the key input unit 302 will be omitted.

The touch panel unit 301 includes an LCD (Liquid Crystal Display) and a transparent electrode bonded to the surface of the LCD. When a finger touches the transparent electrode at a portion corresponding to a key displayed on the LCD, the touch panel unit 301 detects it and displays another operation screen.

FIG. 3 shows the initial screen displayed in the standby mode. The user can cause the touch panel unit to display another operation screen by operating tabs 311 to 315.

The “copy” tab 311 is a tab key to make a transition to an operation screen for a copy operation. The “send” tab 312 is a tab key to make a transition to an operation screen for instructing a FAX or mail send operation. The “box” tab 313 is a tab key to make a transition to an operation screen for storing print ready data in a box or reading out print ready data from a box. The “option 1” tab 314 is a tab key to make a transition to an operation screen for print reservation setting that implements an optional function (time-designated print function). The “option 2” tab 315 is a tab key to make a transition to an operation screen for performing settings related to a web site that implements another optional function (web server function).

Functions (box function, time-designated print function, mail sending function, and web server function) set by the “box” tab 313, “option 1” tab 314, “send” tab 312, and “option 2” tab 315 of the above-described five tab keys will be described below. The description will be made with reference to the operation screens displayed by pressing the tab keys, as needed.

### <4. Explanation of Box Function>

When the user presses the “box” tab 313, the touch panel unit 301 displays a list of print ready data already stored in the data management unit 207. The user selects a time-designated print target from the list. Time-designated printing based on a print reservation setting (to be described later) is executed for the print ready data selected in the “box” tab 313.

### <5. Explanation of Time-Designated Print Function>

### <5.1 Screen for Print Reservation Setting>

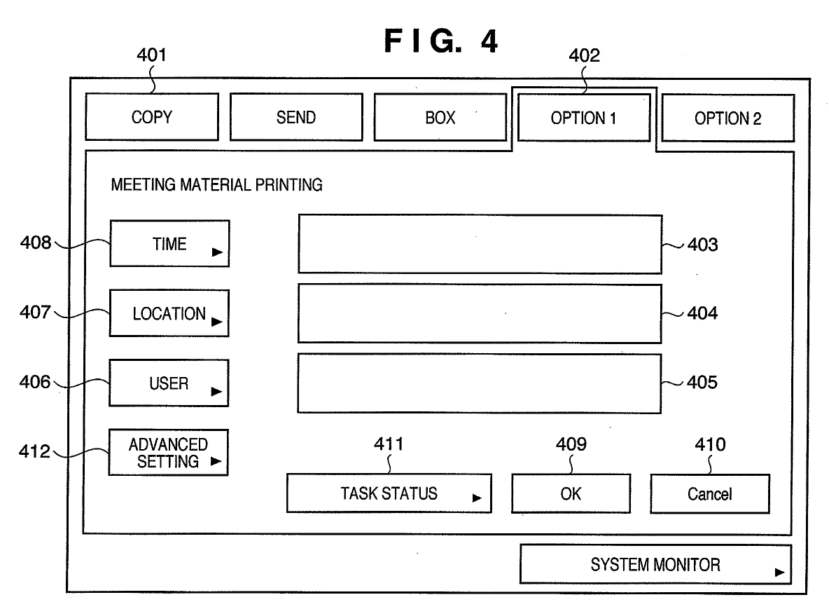

The time-designated print function will be described next with reference to the operation screen (operation screen for print reservation setting) in FIG. 4 which is displayed by pressing the “option 1” tab 314.

FIG. 4 is a view showing an example of the operation screen displayed by pressing the “option 1” tab 314.

A time setting button 408 is used to make a transition to a setting screen (time designation screen) for setting a time of printing (scheduled print time). When the setting is ended, the set scheduled print time is displayed in a time setting display text box 403.

A location setting button 407 is used to make a transition to a setting screen (output location designation screen) for setting a place of printing (output location). When the setting is ended, the set output location is displayed in a location setting display text box 404.

A user setting button 406 is used to make a transition to a setting screen (user selection screen) for setting information about a user who confirms whether to execute printing (a user to whom meeting information is to be sent in this embodiment). When the setting is ended, the set user information is displayed in a user setting display text box 405.

An advanced setting button 412 is used to make a transition to a setting screen for setting information except the scheduled print time, output location, and user information.

An OK button 409 is used to register the print reservation setting. The user cannot press the OK button 409 before a print reservation setting necessary for time-designated printing is made.

When the user presses the OK button 409, a dialogue is displayed to make the user confirm whether to register the print reservation setting. When the user presses the OK button on the dialogue, the print reservation setting is registered.

A task status button 411 is used to make a transition to an operation screen (print reservation setting registration state display screen) for searching for, confirming, or changing a print reservation setting registered in the image forming apparatus 107.

A Cancel button 410 is used to cancel the print reservation setting. When the user presses the Cancel button 410 after setting several items, a confirmation dialogue is displayed to make the user confirm whether to cancel the print reservation setting. When the user presses the OK button on the dialogue, the print reservation setting is deleted. That is, the print reservation setting is not registered. If the user presses the Cancel button 410 without setting any item, a transition to the screen (initial screen) shown in FIG. 3 occurs.

### <5.2 User Selection Screen in Print Reservation Setting>

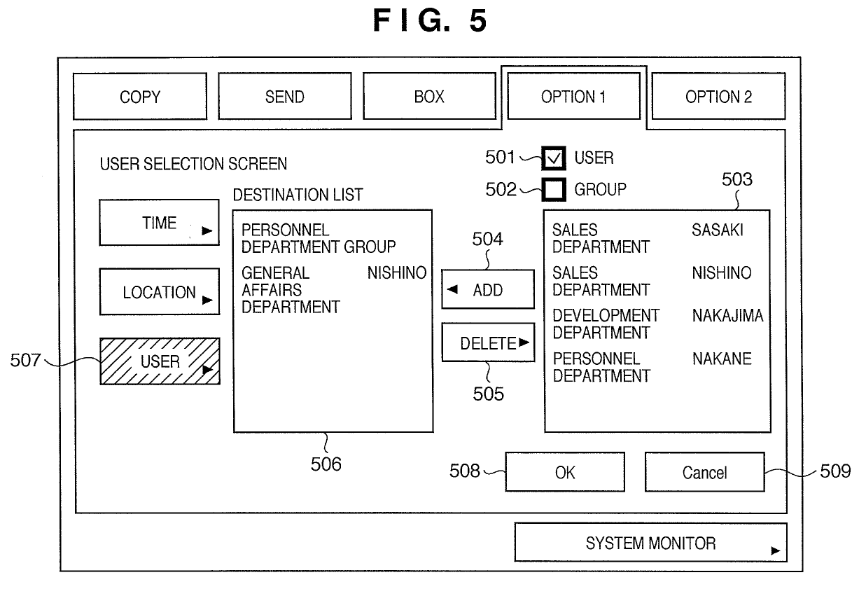

FIG. 5 is a view showing an example of a user selection screen displayed by pressing the user setting button 406.

The user selection screen is a setting screen to set a user who should receive mail (mail of meeting information in this embodiment) and confirm whether printing of print ready data of a time-designated print target is necessary.

A user setting button 507 corresponding to the user setting button 406 in FIG. 4 indicates a pressed state.

Reference numeral 501 denotes a user check box. When the user check box 501 is selected, a list of users who are registered in the image forming apparatus 107 in advance together with their mail addresses is displayed in a list display text box 503. The users and mail addresses can be registered using the user mode key of the key input unit 302, and a detailed description thereof will be omitted here.

Reference numeral 502 denotes a group check box. When the group check box 502 is selected, a list of groups registered in the image forming apparatus 107 in advance is displayed in the list display text box 503. The groups are registered in the same way as in user registration.

Only when a user or group is selected in the list display text box 503, the user can press an add button 504 to add the user or group to a destination list display portion 506.

In contrast with the add button 504, a delete button 505 is used to move a user or group from the destination list display portion 506 to the list display text box 503.

When the user presses an OK button 508, the users or groups displayed in the destination list display portion 506 are set as the destinations to which the meeting information mail is to be sent. If neither users nor groups are displayed in the destination list display portion 506, the user cannot press the OK button 508.

When the user presses a Cancel button 509, all users or groups displayed in the destination list display portion 506 move to the list display text box 503. If neither users nor groups are displayed in the destination list display portion 506, a transition to the operation screen shown in FIG. 4 occurs.

### <5.3 Output Location Designation Screen in Print Reservation Setting>

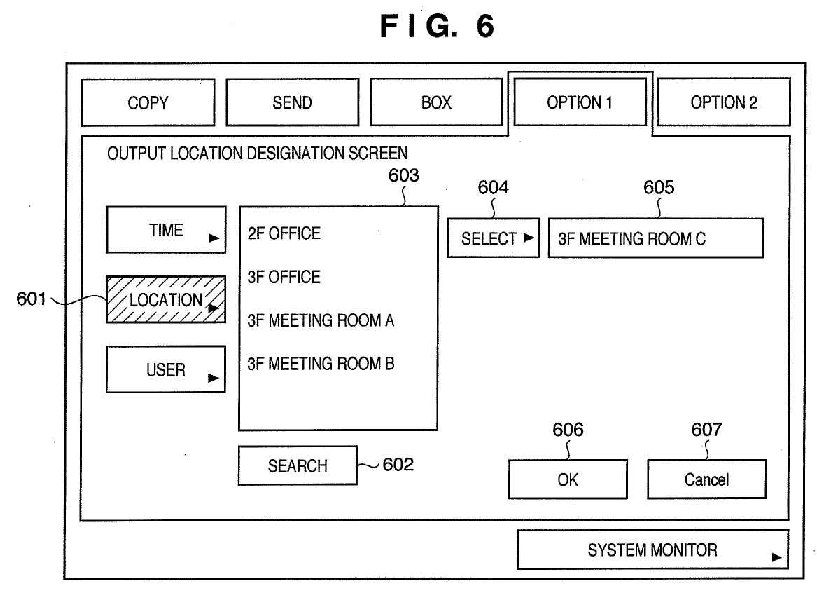

FIG. 6 is a view showing an example of an output location designation screen displayed by pressing the location setting button 407. The output location designation screen is used to set a location to output a printed product.

A location setting button 601 corresponding to the location setting button 407 in FIG. 4 indicates a pressed state.

A search button 602 is used to search for another image forming apparatus (105 or 106) on the network 216. When the user presses the search button 602, the image forming apparatus broadcasts a signal of a predetermined protocol via the NIC unit 211. The locations of image forming apparatuses which have returned a response to the signal are displayed in a search result display portion 603.

A select button 604 is used to select an output destination. The select button 604 can be pressed only when the user has selected an output destination from the list. When the button is pressed, the output destination selected by the user is displayed in a selection result display portion 605. To cancel the selection, the user must select another output destination in the search result display portion 603 or press a Cancel button 607. The output destination selection can be canceled by pressing the Cancel button 607. If no output destination has been selected, a transition to the operation screen shown in FIG. 4 occurs.

When the selected output destination is displayed in the selection result display portion 605, and the user presses an OK button 606 in this state, the output destination is set as the output destination of time-designated printing of a print reservation setting. On the other hand, when no output destination is displayed in the selection result display portion 605, a transition to the operation screen shown in FIG. 4 occurs (in this case, the image forming apparatus 107 is set as the output destination).

### <5.4 Time Designation Screen in Print Reservation Setting>

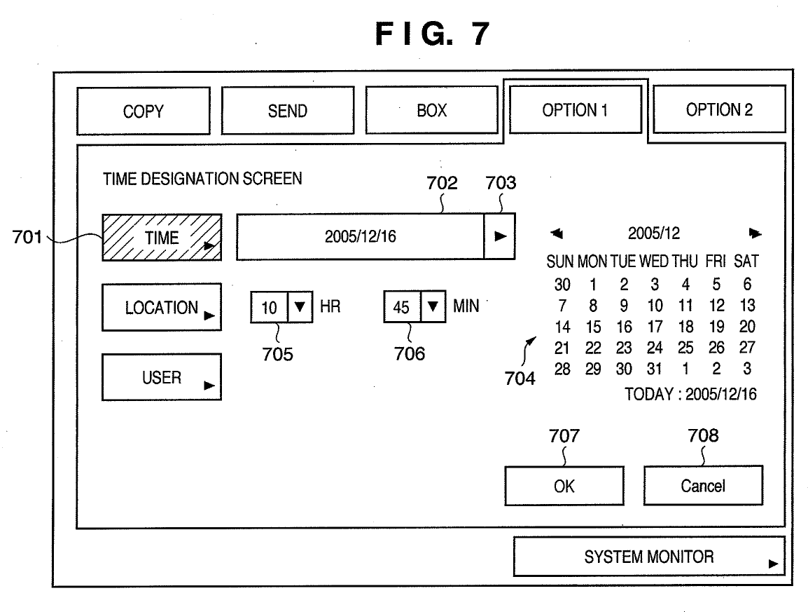

FIG. 7 is a view showing an example of a time designation screen displayed by pressing the time setting button 408. A time setting button 701 corresponding to the time setting button 408 in FIG. 4 indicates a pressed state.

A date select button 703 is used to display a date setting dialogue 704. The user can select a date in the date setting dialogue 704. A date display portion 702 displays the date selected in the date setting dialogue 704. An hour display portion 705 displays a selected time. A minute display portion 706 displays a selected minute.

The user can cancel the selection by pressing a Cancel button 708. When no selection has been done, a transition to the operation screen shown in FIG. 4 occurs.

When the user presses an OK button 707, the selected date, hour, and minute are set as the scheduled print time of a print reservation setting.

If none of a date, hour, and minute is selected, a transition to the operation screen shown in FIG. 4 occurs without setting.

### <5.5 Print Reservation Setting Registration State Display Screen>

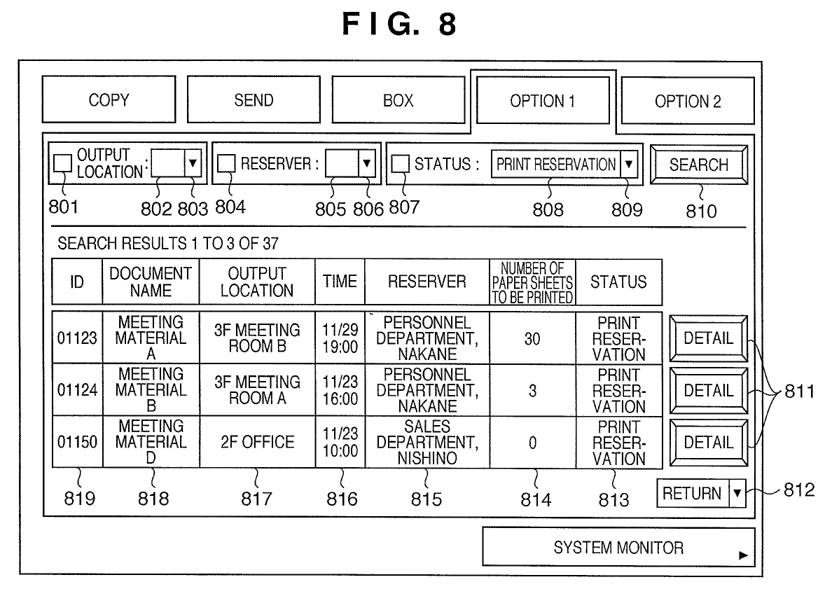

FIG. 8 is a view showing an example of a print reservation setting registration state display screen displayed by pressing the task status button 411.

Check boxes 801, 804, and 807 are used to select an output location, print reserver, and status as search conditions in searching for a predetermined one of print reservation settings that are registered (registered print reservation settings). Only search conditions selected in the check boxes are used in a search to be executed by pressing a search button 810.

A selection list display button 803 is used to set an output location attribute as a search condition for a registered print reservation setting to be found. When the user presses the button, an output location list is displayed. The selection result is displayed in an output location search condition display portion 802.

A selection list display button 806 is used to set a print reserver attribute as a search condition for a registered print reservation setting to be found. When the user presses the button, a reserver list is displayed. The selection result is displayed in a reserver search condition display portion 805.

A selection list display button 809 is used to set a status attribute as a search condition for a registered print reservation setting to be found. When the user presses the button, a status list is displayed. The selection result is displayed in a status search condition display portion 808.

An ID display portion 819 displays an ID uniquely added to each registered print reservation setting found by the search. A document name display portion 818 displays the registered document name of print ready data that is set as the print target of each registered print reservation setting found by the search.

An output location display portion 817 displays the output location set in each registered print reservation setting found by the search. A time display portion 816 displays the scheduled print time set in each registered print reservation setting found by the search.

A print reserver display portion 815 displays the name of the user who has registered each registered print reservation setting found by the search. A print paper count display portion 814 displays the number of paper sheets to be printed, which is currently set in each registered print reservation setting found by the search.

A status display portion 813 displays the current status of each registered print reservation setting found by the search. For an already printed document, “printed” is displayed as a status. If the scheduled print time has not come yet, “reserved” is displayed as a status.

A return button 812 is used to return to the operation screen shown in FIG. 4. When the user presses the button, a transition to the operation screen shown in FIG. 4 occurs.

A detail button 811 is used to browse details of each registered print reservation setting.

### <5.6 Advanced Setting Screen in Print Reservation Setting>

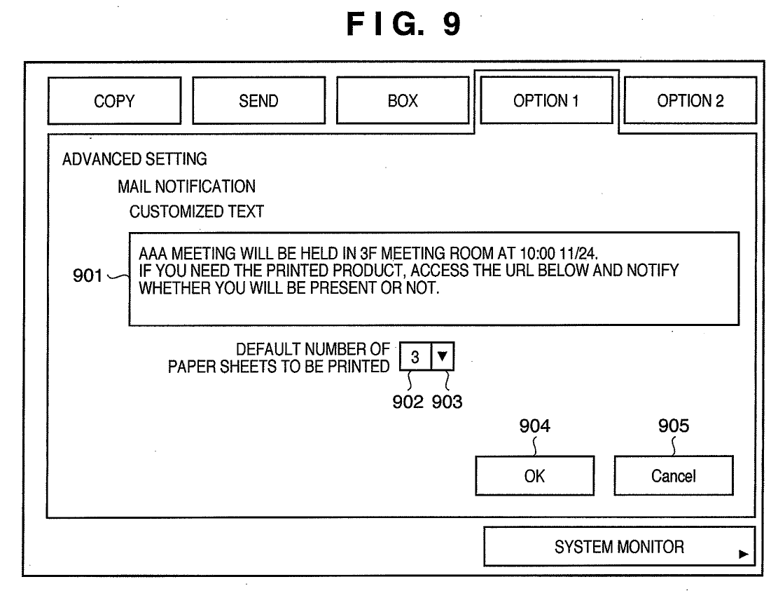

FIG. 9 is a view showing an example of an advanced setting screen displayed by pressing the advanced setting button 412 in FIG. 4. The advanced setting screen is used to set details of time-designated printing.

In a mail notification customized text display portion 901, a customized part of mail to be sent to a user is set. The customized text is input using the soft keyboard function of the image forming apparatus 107.

Reference numeral 902 denotes a default print paper count display portion; and 903, a print paper count setting list button. In the image forming apparatus 107, every time a user accesses the URL (the URL of the web site provided by the image forming apparatus 107) attached to mail of, for example, meeting information and requests printing, the number of paper sheets to be printed is incremented by one. On the other hand, the default print paper count display portion 902 displays the number of paper sheets to be printed, which is set by default independently of the user's print request. Normally, “0” is set in the default print paper count display portion 902 as the initial value.

<6. Web Server Function>

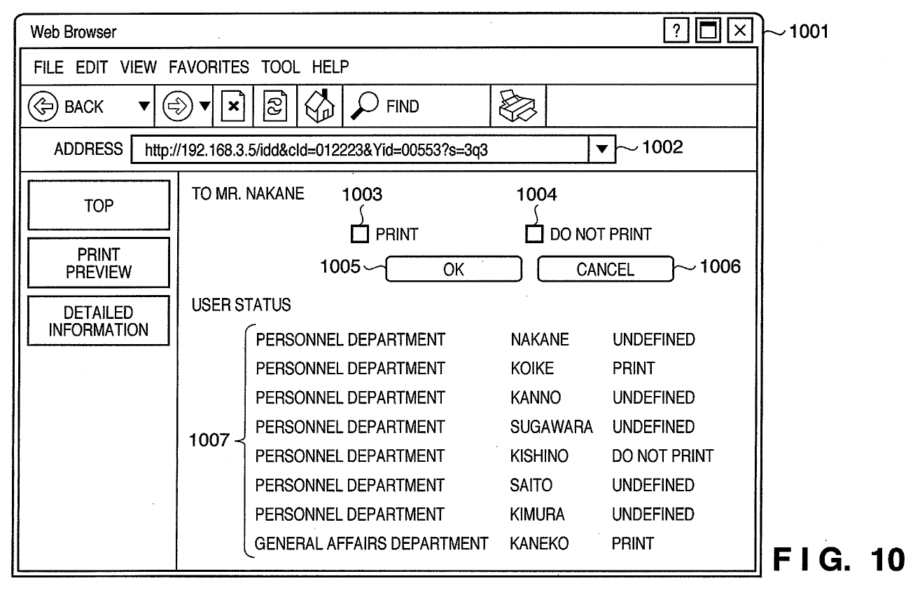

A web site generated in the “option 2” tab 315 will be described next with reference to FIG. 10. FIG. 10 is a view showing an example of a web site generated in the “option 2” tab 315 and accessibly provided to the information processing apparatuses 103 and 104. A user can browse the web site by accessing a URL 1002 using the browser function of the information processing apparatus 103 or 104.

A user who has received meeting information mail designates whether a predetermined meeting material is necessary in attending the meeting by using check boxes 1003 and 1004 on a web site 1001 displayed via the browser. When the user selects the check box 1003 to input a print instruction and presses an OK button 1005, the print request is sent from the information processing apparatus 103 or 104 to the image forming apparatus 107 together with the user name.

Upon receiving the print request, the image forming apparatus 107 increments the currently set print paper count.

When the user selects the check box 1004 to input a non-print instruction and presses the OK button 1005, the non-print request is sent from the information processing apparatus 103 or 104 to the image forming apparatus 107 together with the user name.

A user status display portion 1007 displays the statuses of all users to whom the meeting information mail has been sent. “Undefined” in the user status display portion 1007 indicates a user who has sent neither a print request nor a non-print request. “Print” indicates a user who has sent a print request. “Do not print” displayed in the user status display portion 1007 indicates a user who has sent a non-print request.

When the user presses a cancel button 1006, the browser is terminated.

### <7. Mail Sending Function>

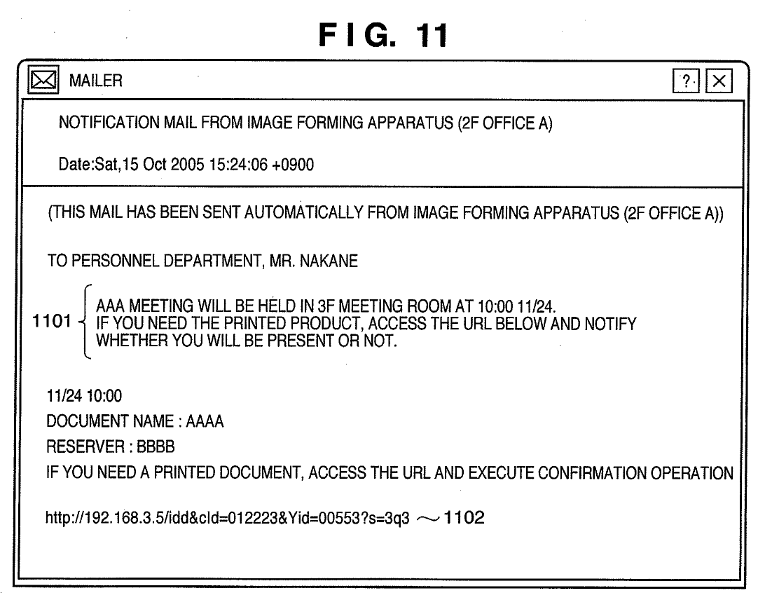

The meeting information mail generated in the “send” tab 312 and sent in accordance with a sending instruction will be described next with reference to FIG. 11. FIG. 11 is a view showing an example of the meeting information mail generated in the “send” tab 312 and sent to the information processing apparatuses 103 and 104. A user receives and browses the mail by using the mail receiving function of the information processing apparatus 103 or 104.

As shown in FIG. 11, the mail generated in the “send” tab 312 and sent contains a customized text that is a text input in the mail notification customized text display portion 901 (FIG. 9) of the “option 1” tab 314 (1101). However, any components other than the customized text can arbitrarily be input in generating the mail in the “send” tab 312.

In this embodiment, the user is supposed to always input the URL of the web site in generating the mail (1102). Hence, any user who has received the mail can access the URL and easily send a print request or a non-print request to the image forming apparatus 107.

The mail generated in the “send” tab 312 is supposed to be sent to only users selected by pressing the user setting button 507 of the “option 1” tab 314. In other words, users selected by pressing the user setting button 507 are set as the destinations of the mail to be sent.

### <8. Sequence of Time-Designated Print Process>

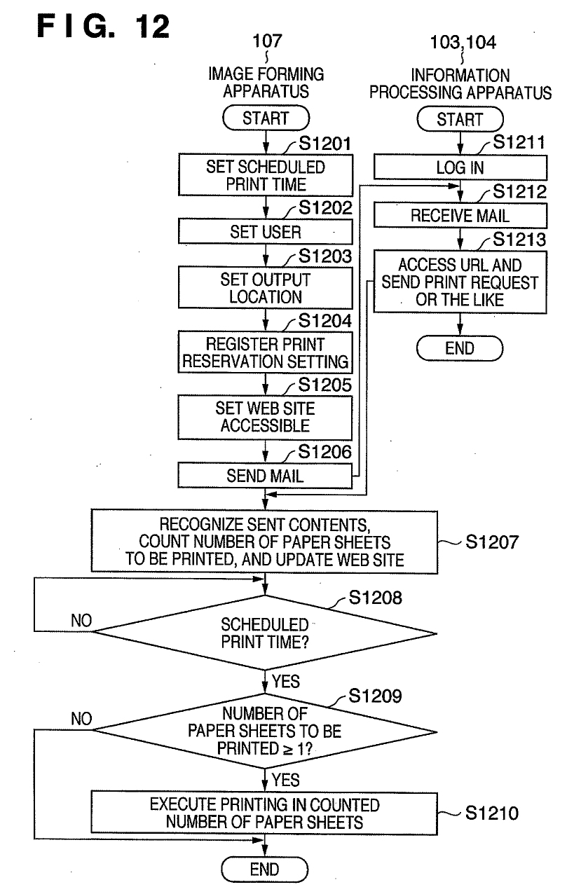

The sequence of a time-designated print process will be described next with reference to FIG. 12. FIG. 12 is a flowchart illustrating the sequence of a time-designated print process in the image forming system according to this embodiment (FIG. 12 shows the process sequence in the image forming apparatus 107 on the left side and that in the information processing apparatus 103 or 104 on the right side).

In step S2101, a scheduled print time input by the user via the time designation screen (FIG. 7) is set. In step S1202, a user input by the user via the user selection screen (FIG. 5) is set as a mail sending destination.

In step S1203, an output location input by the user via the output location designation screen (FIG. 6) is set.

In step S1204, print ready data selected by the user in the “box” tab 313 is registered as a print reservation setting in correspondence with the scheduled print time, user information, and output location.

In step S1205, a web site generated in the “option 2” tab 315 is set to be accessible. In step S1205, meeting information mail (FIG. 11) generated in the “send” tab 312 is sent to the destination set in step S1202.

The information processing apparatus 103 or 104 receives the sent mail (FIG. 11) (step S1212). The user of the information processing apparatus 103 or 104 accesses the URL contained in the mail and displays the web site shown in FIG. 10 on the information processing apparatus 103 or 104 using the browser function. The user determines based on the mail contents in FIG. 11 whether the meeting material is necessary and inputs to the web site in accordance with the determination. The browser sends the input contents to the image forming apparatus 107 as a print request or a non-print request together with the user ID (step S1213). Note that the user inputs the user ID in advance upon logging in to the information processing apparatus 103 or 104 (step S1211).

The image forming apparatus 107 recognizes the print request or non-print request based on the contents sent from the information processing apparatus 103 or 104. The image forming apparatus 107 also recognizes the user ID of the user of the sending source. Based on the recognition result, the image forming apparatus 107 updates the user status on the web site 1001. Upon recognizing the print request, the image forming apparatus 107 increments the number of paper sheets to be printed of the print reservation setting.

In step S1208, it is determined whether the scheduled print time set in step S1201 has come. If it is determined that the scheduled print time has come, the process advances to step S1209 to determine whether the number of paper sheets to be printed is one or more.

If it is determined in step S1209 that the number of paper sheets to be printed is one or more, the process advances to step S1210. In step S1210, the print ready data selected as the print target in the print reservation setting is read out from the data management unit 207 and printed in accordance with the number of paper sheets to be printed recognized in step S1207. On the other hand, if it is determined that the number of paper sheets to be printed is not one or more, the process is ended without executing printing.

As is apparent from the above description, the image forming apparatus according to this embodiment has the web server function in addition to the time-designated print function and is designed to count print requests from the respective information processing apparatuses and automatically reflect the count result on a print reservation setting as the number of paper sheets to be printed.

As a result, the user need not set the number of paper sheets to be printed. This improves the convenience for the user in setting a print reservation in the image forming apparatus having the time-designated print function.

The image forming apparatus according to this embodiment also has the mail sending function. It is therefore possible to add the URL of a web site for counting print requests in sending, for example, meeting information mail to each information processing apparatus. This allows the user of each information processing apparatus to easily access the web site.

### Second Embodiment

In the first embodiment, the image forming apparatus 107 selects print ready data stored in the data management unit 207, designates a scheduled print time, and selects an output location for time-designated printing. However, the present invention is not limited to this. For example, an information processing apparatus connected to the image forming apparatus 107 may be caused to function as a print client having a printer driver so that the user inputs the settings via the printer driver.

### <1. Overall Arrangement of Image Forming System>

The overall arrangement of the image forming system is the same as in the first embodiment (FIG. 1) except that of information processing apparatuses 103 and 104, the information processing apparatus 104 has a printer driver for an image forming apparatus 107. That is, the information processing apparatus 104 functions as a print client for the image forming apparatus 107.

### <2. Arrangement of Image Forming Apparatus 104>

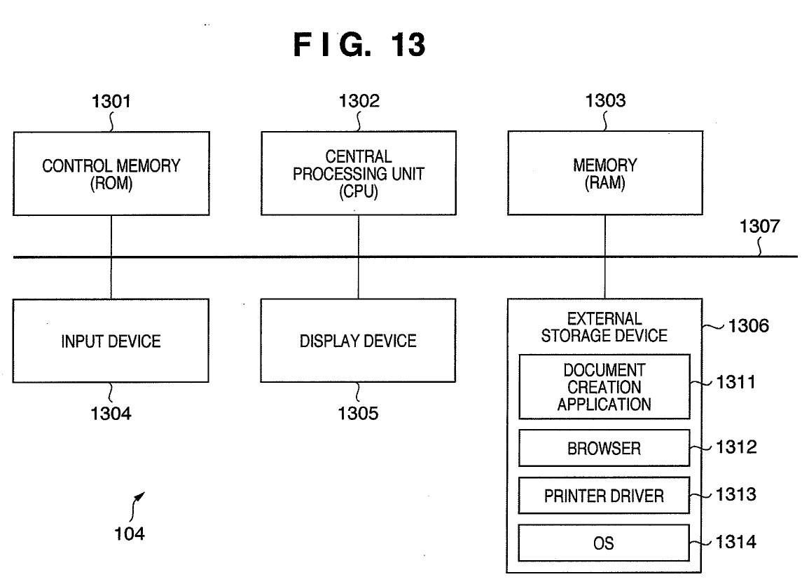

FIG. 13 is a block diagram showing the arrangement of the information processing apparatus 104 in the image forming system according to the second embodiment of the present invention.

Referring to FIG. 13, reference numeral 1301 denotes a control memory (ROM); 1302, a central processing unit (CPU); 1303, a memory (RAM); 1304, an input device; 1305, a display device; 1306, an external storage device; and 1307, a bus. The external storage device 1306 stores a control program for implementing the time-designated print function of this embodiment and data to be used by the control program. More specifically, the external storage device 1306 stores a document creation application 1311 for creating a meeting material, a browser 1312, a printer driver 1313, and an OS 1314.

The control program and the like are loaded in the memory (RAM) 1303 as needed via the bus 1307 under the control of the central processing unit 1302 and executed by the central processing unit 1302.

### <3. Information Input Function for Print Reservation Setting in Information Processing Apparatus 104>

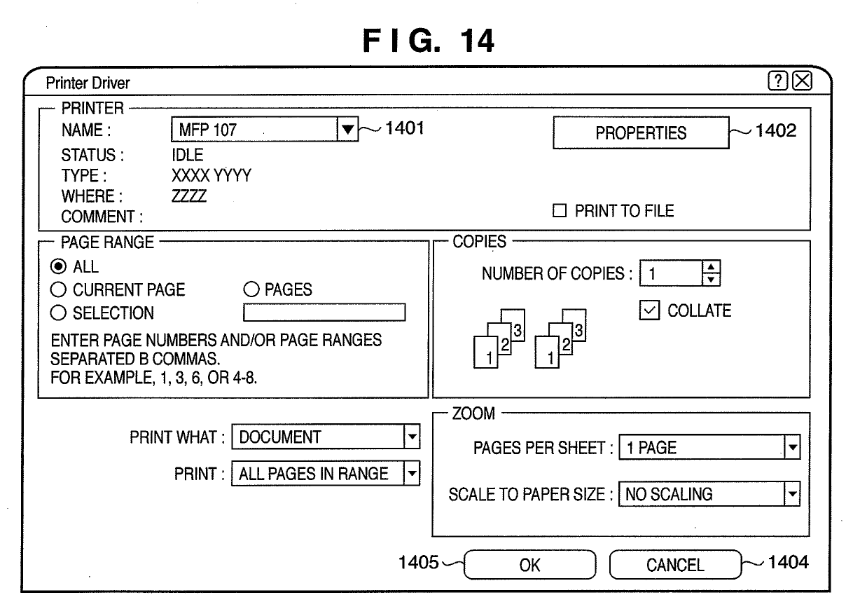

In accordance with a print instruction from the document creation application 1311, the information processing apparatus 104 displays the print control screen of the printer driver 1313 on the display device 1305. The user inputs information for a print reservation setting via the displayed print control screen. The information input function for a print reservation setting in the information processing apparatus 104 will be described below with reference to examples of the print control screen (FIGS. 14 to 17).

### <3.1 Print Control Screen of Printer Driver 1313>

FIG. 14 is a view showing an example of a dialogue of the printer driver 1313, which is displayed by selecting a print instruction in the document creation application 1311. The printer driver 1313 is used as a means for outputting a proof or final result from the document creation application 1311 to a printer unit 219 of the image forming apparatus 107.

The print control screen of the printer driver 1313 is displayed when the user selects the print menu of the document creation application 1311 in outputting a print job in the image forming apparatus 107.

When the user selects an image forming apparatus to be used by a “printer name” pull-down list box 1401 of the print control screen, the status of the selected image forming apparatus is displayed in the “status” field on the lower side. A “type” field displays the type of the printer driver 1313. A “where” field displays the installation location of the selected image forming apparatus. A “comment” field displays comment information from the administrator of the selected image forming apparatus.

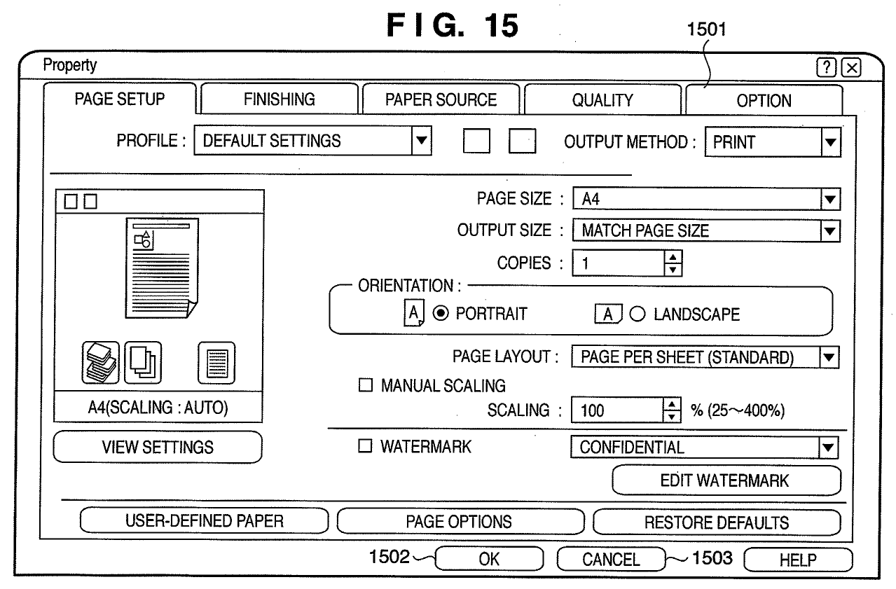

The user can do advanced settings by selecting a “properties” button 1402. FIGS. 15, 16, and 17 show screens for the advanced settings.

When the user finishes settings in the print control screen of the printer driver 1313 and presses an “OK” button 1205, the print job is output to the image forming apparatus 107. To stop output of the print job, the user presses a “cancel” button 1404.

### <3.2 Property Setting Screen of Printer Driver 1313>

FIG. 15 is a view showing an example of a property setting screen. The property setting screen (FIG. 15) of the printer driver 1313 is displayed as a default screen by pressing the “properties” button 1402 of the print control screen of the printer driver 1313. Alternatively, the property setting screen is displayed by selecting the “page setup” tab of the property setting screen of the printer driver 1313. The user sets detailed print properties such as an output style in this screen.

When the user finishes page setup in the property setting screen (FIG. 15) of the printer driver 1313 and presses an “OK” button 1502, the print properties are reflected on actual printing. To stop page setup of the property setting screen (FIG. 15), the user presses a “cancel” button 1503.

### <3.3 Option Screen of Printer Driver 1313>

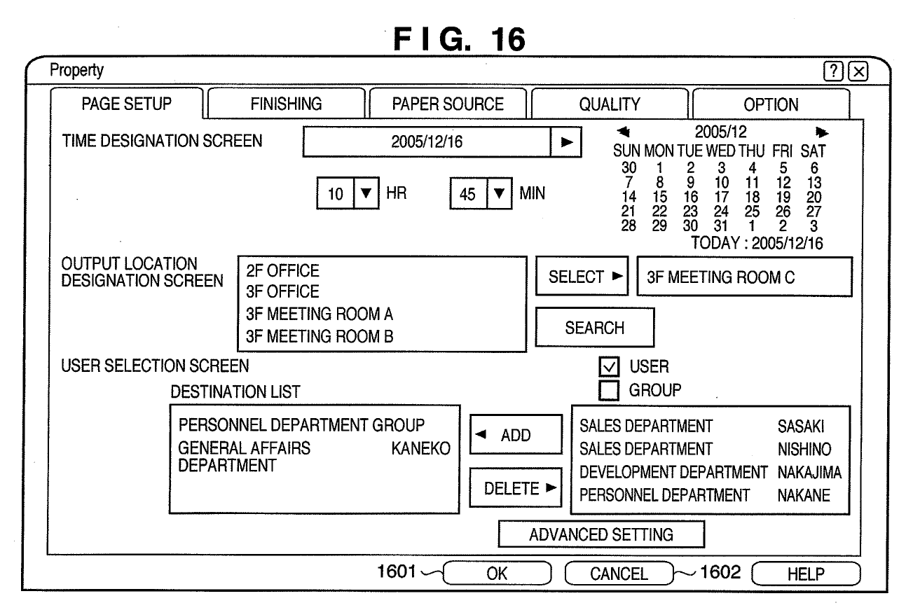

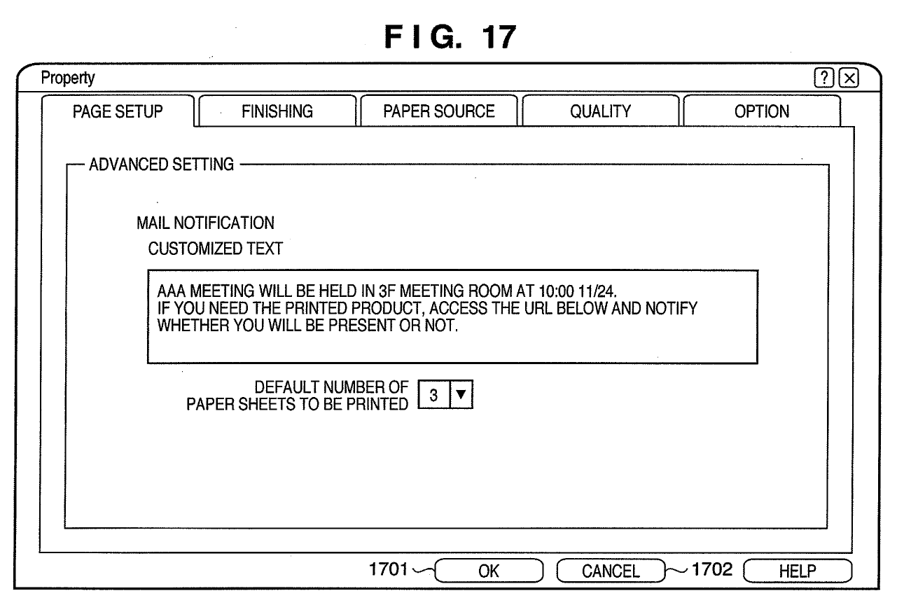

FIGS. 16 and 17 are views showing examples of an option screen to input a scheduled print time, output location, user information, and customized mail text for time-designated printing via the printer driver 1313. The set contents are the same as in the first embodiment, and a description thereof will not be repeated here.

When the user presses an “OK” button (1601 or 1701) or a “cancel” button (1602 or 1702) of the option screen (FIG. 16 or 17), a transition to the print control screen (FIG. 14) occurs.

When the user presses the “OK” button 1405 (FIG. 14), the contents input in the option screen (FIG. 16 or 17) are added to the print job generated by the printer driver 1313 and sent to the image forming apparatus 107.

### <4. Sequence of Time-Designated Print Process>

The sequence of the time-designated print process in the image forming system of this embodiment will be described next.

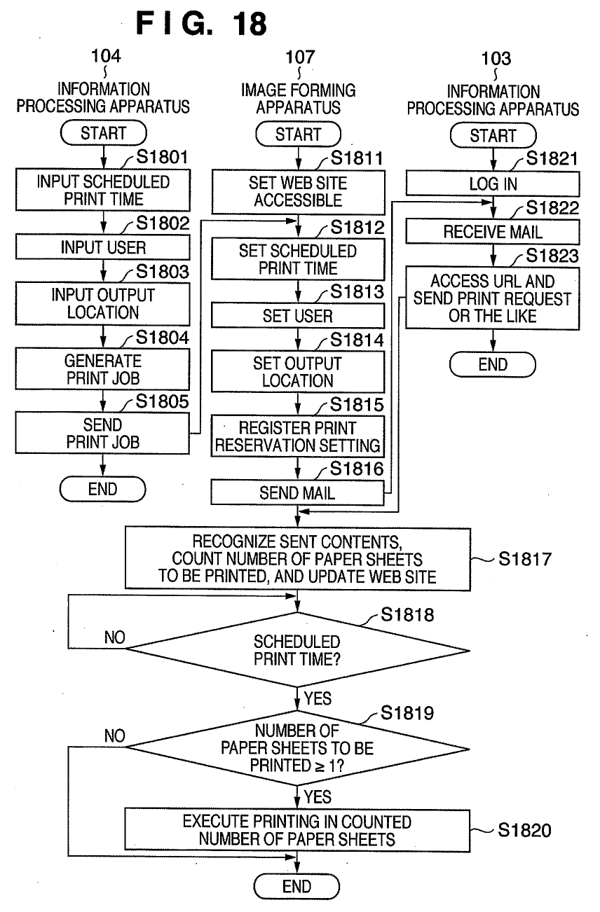

FIG. 18 is a flowchart illustrating the sequence of a process of each apparatus for the time-designated print process in the image forming system according to this embodiment.

FIG. 18 shows the process sequence in information processing apparatus 104 functioning as a print client on the left side, that in the image forming apparatus 107 at the center, and that in the information processing apparatus 103 which receives meeting information mail on the right side.

When the document creation application 1311 of the information processing apparatus 104 outputs a print request, the printer driver 1313 displays the print control screen (FIG. 14). In step S1801, a scheduled print time input by the user via the print control screen is received. In step S1802, user information input by the user via the print control screen is received. In step S1803, an output location input by the user via the print control screen is received.

In step S1804, a print job for data created by the document creation application 1311 is generated. At this time, the contents set in steps S1801 to S1803 are added to the print job. In step S1805, the print job is sent to the image forming apparatus 107.

The image forming apparatus 107 receives the print job sent from the information processing apparatus 104. Before the print job reception, a web site generated in an “option 1” tab 315 is set to be accessible in step S1811.

In step S1812, the scheduled print time added to the received print job is extracted and set in the image forming apparatus 107. In step S1813, the user information added to the received print job is extracted and set in the image forming apparatus 107 as a mail sending destination. In step S1814, the output location added to the received print job is extracted and set in the image forming apparatus 107.

In step S1815, print ready data is generated on the basis of the print job sent from the information processing apparatus 104 to the image forming apparatus 107 and stored in the data management unit 207. The print ready data is registered as a print reservation setting in correspondence with various kinds of settings (scheduled print time, user information, and output location).

In step S1816, meeting information mail (FIG. 11) generated in a “send” tab 312 is sent to the destination set in step S1813.

The information processing apparatus 103 receives the sent mail (step S1822). The user of the information processing apparatus 103 accesses the URL contained in the mail and displays the web site shown in FIG. 10 on the information processing apparatus 103 using the browser function. The user determines based on the mail contents in FIG. 11 whether the meeting material is necessary and enters the web site in accordance with the determination. The browser sends the input contents to the image forming apparatus 107 together with the user ID (step S1823). Note that the user inputs the user ID in advance upon logging in to the information processing apparatus 103 (step S1821).

The image forming apparatus 107 recognizes the print request or non-print request based on the contents sent from the information processing apparatus 103. The image forming apparatus 107 also recognizes the user ID of the user of the sending source. Based on the recognition result, the image forming apparatus 107 updates the user status on a web site 1001. Upon recognizing the print request, the image forming apparatus 107 increments the number of paper sheets to be printed of the print reservation setting.

In step S1818, it is determined whether the scheduled print time set in step S1812 has come. If it is determined that the scheduled print time has come, the process advances to step S1819 to determine whether the number of paper sheets to be printed is one or more.

If it is determined in step S1819 that the number of paper sheets to be printed is one or more, the process advances to step S1820. In step S1820, the print ready data of the print target is read out from the data management unit 207 and printed in accordance with the number of paper sheets to be printed recognized in step S1817. On the other hand, if it is determined that the number of paper sheets to be printed is not one or more, the process is ended without executing printing.

As is apparent from the above description, the image forming apparatus has the web server function in addition to the time-designated print function and is designed to count print requests from the respective information processing apparatuses and automatically reflect the count result on a print reservation setting as the number of paper sheets to be printed, as in the first embodiment.

As a result, the user need not set the number of paper sheets to be printed. This improves the convenience for the user in setting a print reservation in the image forming apparatus having the time-designated print function.

The image forming apparatus also has the mail sending function, as in the first embodiment. It is therefore possible to add the URL of a web site for counting print requests in sending, for example, meeting information mail to each information processing apparatus. This allows the user of each information processing apparatus to easily access the web site.

The image forming apparatus according to this embodiment imparts the information input function for a print reservation setting to the printer driver of the information processing apparatus. The image forming apparatus executes settings based on various kinds of information sent together with a print job. This enables the user of the information processing apparatus to input a print reservation setting.

### Other Embodiments

The present invention is also applicable to a system including a plurality of devices (e.g., host computer, interface device, reader, and printer) or an apparatus (e.g., copying machine or facsimile apparatus) including a single device.

The object of the present invention is achieved even by supplying a storage medium which records software program codes for implementing the functions of the above-described embodiments to the system or apparatus. In this case, the functions are implemented by causing the computer (or CPU or MPU) of the system or apparatus to read out and execute the program codes stored in the storage medium. In this case, the storage medium which stores the program codes constitutes the present invention.

Examples of the storage medium usable to supply the program codes are a Floppy® disk, hard disk, optical disk, magnetooptical disk, CD-ROM, CD-R, magnetic tape, nonvolatile memory card, and ROM.

The functions of the above-described embodiments are implemented not only when the computer executes the readout program codes but also when the OS (Operating System) running on the computer partially or wholly executes actual processing based on the instructions of the program codes.

The functions of the above-described embodiment are also implemented when the program codes read out from the storage medium are written in the memory of a function expansion board inserted into the computer or a function expansion unit connected to the computer, and the CPU of the function expansion board or function expansion unit partially or wholly executes actual processing based on the instructions of the program codes.

The present invention is not limited to the above-described embodiments. Various changes and modifications can be made without departing from the spirit and scope of the present invention, and therefore reference is made to the appended claims which follow the description for determining the scope of the invention.

This application claims the benefit of Japanese Patent Application No. 2007-054887, filed Mar. 5, 2007, which is hereby incorporated by reference herein in its entirety.

1. An image forming apparatus communicably connected to a plurality of information processing apparatuses, comprising:
a storage unit configured to store print data;
a setting unit configured to set information representing a timing of printing the print data;
a count unit configured to receive a print request of the print data from any one of the plurality of information processing apparatuses and counting the number of print requests;
a print unit configured to print the print data in number based on the counted number at the set timing.

2. The image forming apparatus according to claim 1, further comprising a mail sending unit configured to send mail containing a URL of an object for counting the number of print requests to the plurality of information processing apparatuses.

3. The image forming apparatus according to claim 1, wherein the apparatus is communicably connected to an information processing apparatus having a driver for operating said print unit,
said storage unit stores print data generated on the basis of a print job which is generated by the driver and sent from the information processing apparatus having the driver, and
said setting unit extracts information representing a timing of printing the print data, which is set via the driver, from the sent print job and sets the information.

4. A data processing method of causing a printing apparatus to print print data, comprising:
the setting step of setting information representing a timing of printing the print data stored in a storage device;
the cont step of receiving a print request of the print data from a plurality of users and counting the number of print requests; and
the instruction step of instructing the printing apparatus to print the print data in number based on the counted number at the set timing.

5. A control program for causing a computer to implement a data processing method of claim 4.
